(19) United States
(12) Patent Application Publication
(10) Pub. No.: US 2026/0053306 A1
(43) Pub. Date: Feb. 26, 2026

(54) LIQUID LEVEL DETECTION APPARATUS, SEWAGE TANK HAVING LIQUID LEVEL DETECTION APPARATUS, AND CLEANING DEVICE

(71) Applicant: SHANGHAI ZIDONG TECHNOLOGY CO., LTD., Shanghai (CN)

(72) Inventors: Linggang ZENG, Shanghai (CN); Zihao CHENG, Shanghai (CN); Weidong LU, Shanghai (CN)

(73) Assignee: SHANGHAI ZIDONG TECHNOLOGY CO., LTD., Shanghai (CN)

(21) Appl. No.: 19/304,826

(22) Filed: Aug. 20, 2025

Related U.S. Application Data
(63) Continuation of application No. PCT/CN2023/080896, filed on Mar. 10, 2023.

(30) Foreign Application Priority Data
Mar. 1, 2023 (CN) 202320359068.3

(51) Int. Cl. A47L 7/00; G01F 23/72

(52) U.S. Cl. CPC A47L 7/0028; G01F 23/72

(57) ABSTRACT

The disclosure discloses a liquid level detection apparatus, including a floater and a floater accommodating portion, wherein the floater moves in the floater accommodating portion in a vertical direction; an upper clamping portion and a lower clamping portion are provided on the floater in the vertical direction, a moving groove is formed in the floater accommodating portion, the moving groove extends in the vertical direction, and the upper clamping portion and the lower clamping portion move in the moving groove in the vertical direction; and a clamping groove is formed in the moving groove extending along a horizontal direction, and when the liquid level detection apparatus inclines, the upper clamping portion offsets into the clamping groove, such that the floater not easily be sucked to block a suction port, thereby avoiding resulting in the phenomenon that an alarm is given when the water is not full in fact.

### CROSS-REFERENCE TO RELATED APPLICATION(S)

The disclosure is a continuation of the PCT International Application No: PCT/CN2023/080896 filed on 10 Mar., 2023, which claims the priority of Chinese Patent Application 202320359068.3, filed in the China Patent Office on Mar. 1, 2023, and entitled “Liquid Level Detection Apparatus, Sewage Tank Having Liquid Level Detection Apparatus, and Cleaning Device”, the entire contents of which are herein incorporated by reference.

### FIELD

The disclosure relates to the technical field of cleaning devices, and in particular, to a liquid level detection apparatus, a sewage tank having the liquid level detection apparatus, and a cleaning device.

### BACKGROUND

With the improvement of living standards, auxiliary cleaning devices for household hygiene cleaning have emerged as the times require. These cleaning apparatuses may reduce the amount of labor that users pay in household cleaning, and thus are widely favored in the current society.

Most water fullness alarm structures of sewage tanks of existing cleaning devices are of structures with floaters, the floater floats upwards along with the rise of the water level in the sewage tank, and finally blocks a suction port, such that a suction motor stalls and heats until the current suddenly changes, and the system detects the sudden change of the current, so as to prompt the user of water fullness of the sewage tank. However, during actual use, due to high instantaneous power and a large suction force when the suction motor is started, when the cleaning device is just started, the floater is sucked by the suction force to block the suction port, resulting in the phenomenon that an alarm is given when the water is not full in fact.

### SUMMARY

Aim at the defects in the related art, one objective of the disclosure is to provide a liquid level detection apparatus. The liquid level detection apparatus includes a floater and a floater accommodating portion, wherein an upper clamping portion and a lower clamping portion are provided on the floater in the vertical direction, a clamping groove is formed in a moving groove of the floater accommodating portion extending along a horizontal direction, when a sewage tank inclines, the upper clamping portion offsets into the clamping groove to play a limiting role, such that the floater not easily be sucked by a suction force to block a suction port, thereby avoiding resulting in the phenomenon that an alarm is given when the water is not full in fact.

In order to achieve the above objective, the technical means provided in the disclosure is as follows: a liquid level detection apparatus, including a floater and a floater accommodating portion, wherein the floater moves in the floater accommodating portion in a vertical direction; an upper clamping portion and a lower clamping portion are provided on the floater in the vertical direction, a moving groove is formed in the floater accommodating portion, the moving groove extends in the vertical direction, and the upper clamping portion and the lower clamping portion move in the moving groove in the vertical direction; and a clamping groove is formed in the moving groove extending along the horizontal direction, and when the liquid level detection apparatus inclines, the upper clamping portion offsets into the clamping groove.

In an embodiment mode, the upper clamping portion is cylindrical, and the clamping groove is an arc-shaped groove, such that when the floater floats upwards under the action of buoyancy, the upper clamping portion is able to be easily released from the clamping groove.

In an embodiment mode, a width of an inner cavity of the floater accommodating portion is greater than a width of the floater, such that the floater offsets in the floater accommodating portion. If the width of the inner cavity of the floater accommodating portion is the same as the width of the floater, when the liquid level detection apparatus inclines, the upper clamping portion cannot offset into the clamping groove.

In an embodiment mode, a distance between the clamping groove and a lower end of the moving groove is the same as a distance between the upper clamping portion and the lower clamping portion. At this time, when the lower clamping portion is located at the lowest side of the moving groove of the floater accommodating portion, the upper clamping portion and the clamping groove are located on the same horizontal plane, and when the liquid level detection apparatus inclines, the upper clamping portion offsets into the clamping groove under the action of the gravity of the floater; and if the distance between the clamping groove and the lower end of the moving groove is less than the distance between the upper clamping portion and the lower clamping portion, after the liquid level detection apparatus inclines, the upper clamping portion cannot offset into the clamping groove under the action of the gravity of the floater.

In an embodiment mode, the floater includes an upper portion and a lower portion, the upper portion moves in the floater accommodating portion, and the lower portion extends towards one side, such that an included angle is formed between the upper portion and the lower portion. When a user does not use a cleaning device, a sewage tank is in an upright state, at this time, the upper portion is in an upright state perpendicular to the horizontal plane, and the lower portion inclines towards a use side of the user; and when the user uses the cleaning device, the sewage tank is in an inclined state, at this time, the upper portion is in the inclined state, the lower portion is in the upright state perpendicular to the horizontal plane, the acting force of water in the sewage tank on the floater is in a vertical state, and other component forces are not generated. Compared with a straight plate type floater, a bent floater achieves the same buoyancy effect as the straight plate type floater through a smaller size, thereby increasing the actual capacity of the sewage tank.

Another objective of the disclosure is to provide a sewage tank, including a tank body, a tank cover, and the above-mentioned liquid level detection apparatus. The tank body is configured for storing dirt sucked by a cleaning device; the tank cover is detachably connected to the tank body, and a suction port is formed in the tank cover; and the liquid level detection apparatus is located in the sewage tank and is configured for detecting a liquid level in the tank body, wherein the liquid level detection apparatus is any liquid level detection apparatus mentioned above.

In an embodiment mode, the floater is located below the suction port, and the floater is able to block the suction port. The floater floats upwards along with the rise of the water level in the sewage tank, and finally blocks the suction port, such that a suction motor stalls and heats until the current suddenly changes, and the system detects the sudden change of the current, so as to prompt the user of water fullness of the sewage tank.

In an embodiment mode, the liquid level detection apparatus further includes a sensor, and the floater is provided below the sensor. The sensor is a magnetic signal sensor, a magnetic portion is provided an upper of the floater, when the magnetic portion approaches to the magnetic signal sensor, the magnetic signal sensor is triggered by the magnetic portion and emit a signal, so as to indicate a position where the magnetic portion is located at this time, that is, indicate the liquid level at this time, thereby achieving the function of liquid level detection.

In an embodiment mode, the sewage tank further includes a solid-liquid separation apparatus, and one end of the solid-liquid separation apparatus is hinged with the floater accommodating portion, such that the solid-liquid separation apparatus rotates relative to the floater accommodating portion, and thus the solid dirt in the solid-liquid separation apparatus is poured conveniently.

In an embodiment mode, an outer side of the floater accommodating portion is provided with an open accommodating groove, one end of the solid-liquid separation apparatus is provided with a protrusion, and the protrusion is placed in the open accommodating groove, such that the solid-liquid separation apparatus rotates relative to the floater accommodating portion. By means of setting the open accommodating groove, the protrusion is conveniently installed in the open accommodating groove, and thus the solid-liquid separation apparatus is conveniently detached from the floater accommodating portion.

In an embodiment mode, the other end of the solid-liquid separation apparatus is clamped with the floater accommodating portion or the tank cover, such that the solid-liquid separation apparatus is stably connected to the floater accommodating portion or the tank cover.

In an embodiment mode, an outer wall of the solid-liquid separation apparatus is provided with a handle, thereby facilitating the operation of the user.

In an embodiment mode, the tank body includes a tank body main body having an accommodating cavity, and a liquid inlet pipe extending from a bottom end of the tank body main body into the accommodating cavity, and the solid-liquid separation apparatus communicates with the liquid inlet pipe.

In an embodiment mode, the solid-liquid separation apparatus includes a mounting hole, a bottom plate and a lateral plate, the mounting hole is formed in the bottom plate, a lower end of the lateral plate is connected with an outer edge of the bottom plate, the bottom plate is provided with a plurality of water leakage holes, and the mounting hole allows the liquid inlet pipe to pass through.

In an embodiment mode, a part of the lateral plate abuts against the floater accommodating portion.

In an embodiment mode, the liquid level detection apparatus is detachably connected to the tank cover, the liquid level detection apparatus is taken out when the tank cover is taken out, such that the solid-liquid separation apparatus connected with the liquid level detection apparatus is taken out, in this way, the solid-liquid separation apparatus is flushed without staining hands.

Another objective of the disclosure is to provide a cleaning device, including the above-mentioned sewage tank, wherein the sewage tank is detachably assembled on the cleaning device.

The beneficial effects of the disclosure are: the liquid level detection apparatus of the disclosure includes the floater and the floater accommodating portion, the upper clamping portion and the lower clamping portion are provided on the floater in the vertical direction, the clamping groove is formed in the moving groove of the floater accommodating portion extending along the horizontal direction, and when the sewage tank inclines, the upper clamping portion offsets into the clamping groove to play a limiting role, such that the floater not easily be sucked by the suction force to block the suction port, thereby avoiding resulting in the phenomenon that an alarm is given when the water is not full in fact.

### BRIEF DESCRIPTION OF DRAWINGS

FIG. 1 is a schematic structural diagram of a cleaning device 1000 according to an embodiment mode of the disclosure;

FIG. 2 is a schematic structural diagram of a sewage tank 100 according to an embodiment mode of the disclosure;

FIG. 3 is a cross-sectional view of the sewage tank 100 according to an embodiment mode of the disclosure;

FIG. 4 is a cross-sectional view of a liquid level detection apparatus 130 and a solid-liquid separation apparatus 140 according to an embodiment mode of the disclosure, when a floater 131 is at the bottommost end and the sewage tank 100 is in an upright state;

FIG. 5 is a schematic structural diagram of the liquid level detection apparatus 130 and the solid-liquid separation apparatus 140 according to an embodiment mode of the disclosure, when the floater 131 is at the bottommost end and the sewage tank 100 is in the upright state;

FIG. 6 is a cross-sectional view of the liquid level detection apparatus 130 and the solid-liquid separation apparatus 140 according to an embodiment mode of the disclosure, when the floater 131 is at the bottommost end and the sewage tank 100 is in an inclined state;

FIG. 7 is a schematic structural diagram of the liquid level detection apparatus 130 and the solid-liquid separation apparatus 140 according to an embodiment mode of the disclosure, when the floater 131 is at the bottommost end and the sewage tank 100 is in the inclined state;

FIG. 8 is a cross-sectional view of a connecting structure of the liquid level detection apparatus 130 and the solid-liquid separation apparatus 140 according to an embodiment mode of the disclosure; and

FIG. 9 is a schematic diagram of the connecting structure of the liquid level detection apparatus 130 and the solid-liquid separation apparatus 140 according to an embodiment mode of the disclosure.

The drawings include the following reference signs:

1000. cleaning device; 100. sewage tank; 110. tank body; 111. liquid inlet pipe; 120. tank cover; 121. suction port; 130. liquid level detection apparatus; 131. floater; 1311. upper clamping portion; 1312. lower clamping portion; 1313. upper portion; 1314. lower portion; 1315. groove; 132. floater accommodating portion; 1321. moving groove; 1322. clamping groove; 1323. open accommodating groove; 1324. clamping groove; 140. solid-liquid separation apparatus; 141. protrusion; 142. clamping block; 143. handle; 144. mounting hole; 145. bottom plate; 146. lateral plate; 147. water leakage hole.

### DESCRIPTION OF EMBODIMENTS

According to requirements, specific embodiments of the disclosure will be disclosed herein. However, it should be understood that, the embodiments disclosed herein are merely exemplary examples of the disclosure, and may be embodied in various forms. Therefore, specific details disclosed herein are not considered to be restrictive, but merely as a basis for claims and as a representative basis for teaching those skilled in the art to variously employ the disclosure in any suitable manner in practice, and the specific details include various features disclosed herein and incorporate features that may not be explicitly disclosed herein.

In the description of disclosure, it should be understood that, orientation or position relationships indicated by terms “length”, “upper”, “lower”, “front”, “rear” , “left”, “right”, “horizontal”, “top”, “bottom”, “inner”, “outer”, “circumferential” and the like are base on orientation or position relationships shown in the drawings, are merely for the convenience of describing the disclosure and simplifying the description, rather than indicating or implying that the referred apparatuses or elements must have particular orientations, or constructed and operated in particular orientations, and therefore cannot be understood as limitations to the disclosure.

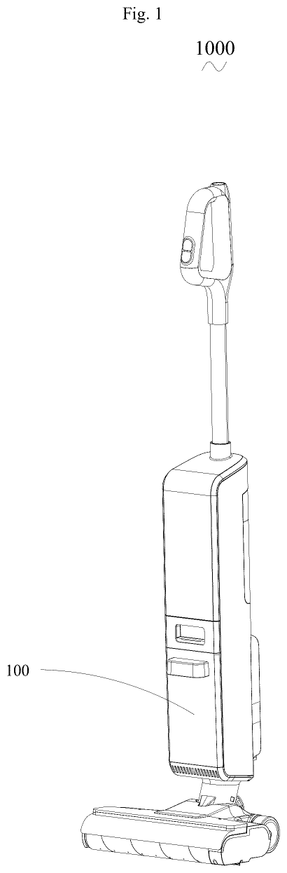

In the embodiments of disclosure, a cleaning device 1000 includes, but not limited to, a cleaning machine, a floor washing robot, and other devices. Taking it as an example that the cleaning device 1000 is a cleaning machine in FIG. 1, the cleaning device 1000 includes a sewage tank 100. A suction motor works to generate a negative pressure, the function of collecting dirt is achieved by a floor brush, and the dirt is collected into the sewage tank 100, such that a surface to be cleaned is kept dry. The surface to be cleaned includes the ground, and the surface of a carpet, the surface of a sofa, and the like. For the convenience of description, the ground is taken as an example for description below.

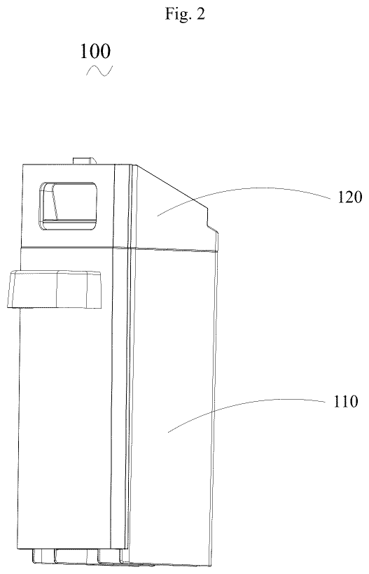

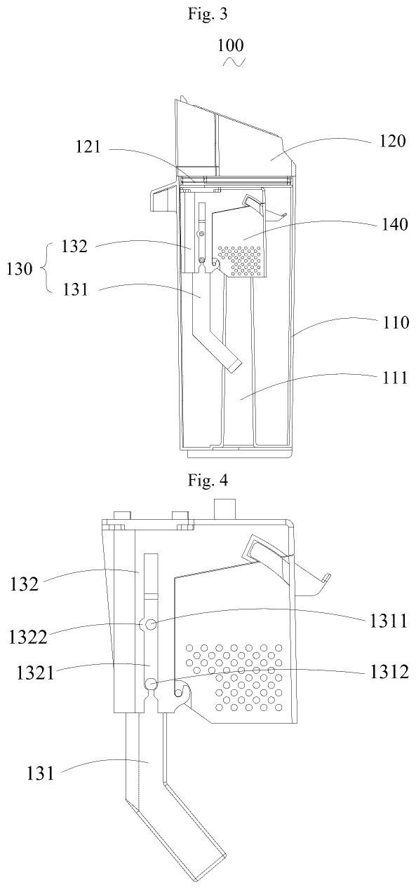

As shown in FIG. 2 and FIG. 3, the sewage tank 100 includes a tank body 110 for storing dirt sucked by the cleaning device 1000; a tank cover 120, which is detachably connected to the tank body 110, wherein the tank cover 120 is provided with a suction port 121, and the air in the sewage tank 100 is sucked out by the suction port 121, such that there is a pressure difference between the sewage tank 100 and the external atmospheric pressure, the sewage tank 100 is in a negative pressure state, and thus sewage is sucked into the sewage tank 100; and a liquid level detection apparatus 130, which is located in the sewage tank 100 and is configured for detecting the liquid level in the tank body 110, wherein the liquid level detection apparatus 130 includes a floater 131 and a floater accommodating portion 132, and the floater 131 moves in the floater accommodating portion 132 in the vertical direction. In the present embodiment, the liquid level detection apparatus 130 is detachably connected with the tank cover 120 and extends into the tank body 110, thereby facilitating the replacement and installation of the liquid level detection apparatus 130. In other embodiments, the liquid level detection apparatus 130 is able to be fixedly connected with the tank cover 120, so as to improve the connection strength, and in addition, the liquid level detection apparatus 130 is able to be provided in the tank body 110, which is not specifically limited herein.

As shown in FIG. 3, in an embodiment mode, the tank body 110 includes a tank body main body having an accommodating cavity, and a liquid inlet pipe 111 extending from a bottom end of the tank body main body into the accommodating cavity. Dirt such as sewage enters the sewage tank 100 through the liquid inlet pipe 111.

In the present embodiment, the floater 131 is located below the suction port 121, and the floater 131 is able to block the suction port 121. The floater 131 floats upwards along with the rise of the water level in the sewage tank 100, and finally blocks the suction port 121, such that the suction motor stalls and heats until the current suddenly changes, and the system detects the sudden change of the current, so as to prompt the user of water fullness of the sewage tank 100. In other embodiments, a sensor is able to be added into the liquid level detection apparatus 130, and the floater 131 is provided below the sensor, therefore liquid level detection is implemented by using the movement of the sensor and the floater 131. For example, the sensor is a magnetic signal sensor, which is installed in the tank cover, at this time, a magnetic portion is provided an upper of the floater 131, the magnetic portion is a permanent magnet or a magnet, the floater 131 is made of a low-density material, for example, foamed plastic or the like, the density of the floater 131 is less than that of water, when the water level in the tank body 110 is relatively low, the floater 131 is located at the bottom of the floater accommodating portion 132, and as the liquid level rises, the floater 131 moves upwards along the floater accommodating portion 132. When the magnetic portion approaches to the magnetic signal sensor, the magnetic signal sensor is triggered by the magnetic portion and emits a signal, so as to indicate a position where the magnetic portion is located at this time, that is, indicate the liquid level at this time. Specifically, the magnetic signal sensor is a Hall sensor or a reed switch apparatus. Or, the senor is a photoelectric sensor and emits a light beam towards the floater 131, the floater 131 blocks the light beam and reflects back a part of light, the receiving end of the photoelectric sensor receives the light reflected back by the floater 131, when the water level in the tank body 110 is relatively low, the floater 131 is located at the bottom of the floater accommodating portion 132, at this time, the receiving end of the photoelectric sensor receives the light reflected by the floater 131 within a relatively long time, as the liquid level rises, the floater 131 moves upwards along the floater accommodating portion 132, the time required by the receiving end of the photoelectric sensor for receiving the light reflected back by the floater 131 is also reduced accordingly, and when the time reaches a set threshold value, the cleaning device is controlled to stop running.

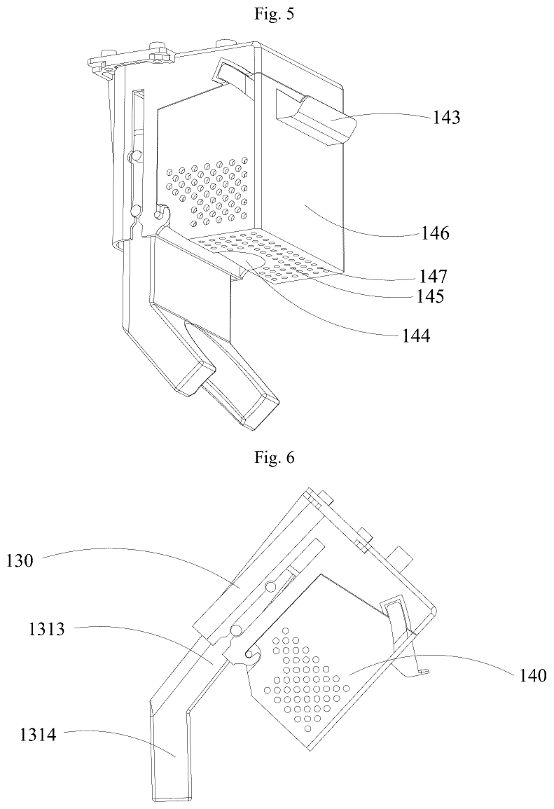

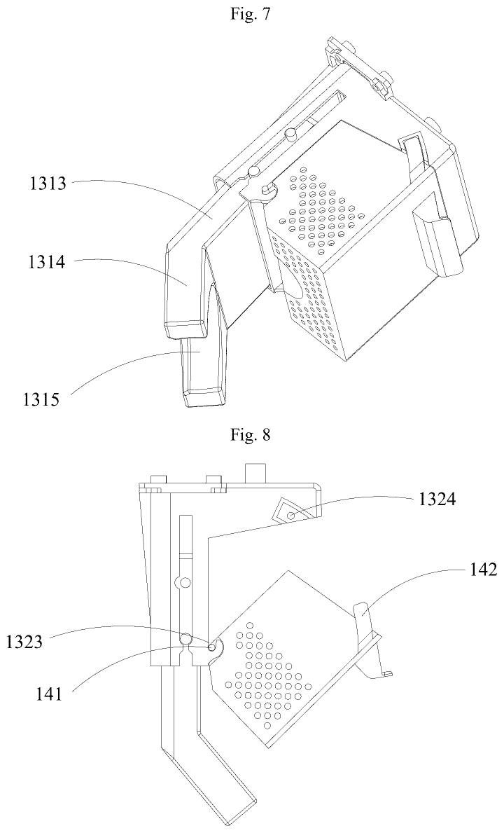

As shown in FIG. 4 and FIG. 5, an upper clamping portion 1311 and a lower clamping portion 1312 are provided on the floater 131 in the vertical direction, a moving groove 1321 is formed in the floater accommodating portion 132, the moving groove 1321 extends in the vertical direction, and the upper clamping portion 1311 and the lower clamping portion 1312 move in the moving groove 1321 in the vertical direction; and as shown in FIG. 6 and FIG. 7, a clamping groove 1322 is formed in the moving groove 1321 extending along the horizontal direction, when the user uses the cleaning device 1000, the sewage tank 100 inclines, the liquid level detection apparatus 130 located in the sewage tank 100 inclines accordingly, at this time, the floater 131 inclines upwards under the influence of gravity, such that the upper clamping portion 1311 offsets into the clamping groove 1322 to play a limiting role, accordingly, the floater 131 not easily be sucked by a suction force to block the suction port 121, thereby avoiding resulting in the phenomenon that an alarm is given when the water is not full in fact.

Specifically, the upper clamping portion 1311 is cylindrical, and the clamping groove 1322 is an arc-shaped groove, such that when the floater 131 floats upwards under the action of buoyancy, the upper clamping portion 1311 is easily released from the clamping groove 1322.

The inner wall of the floater accommodating portion 132 is enclosed to form an inner cavity of the floater accommodating portion 132, and the floater 131 is located in the inner cavity of the floater accommodating portion 132. The width of the inner cavity of the floater accommodating portion 132 is greater than the width of the floater 131, such that the floater 131 offsets in the floater accommodating portion 132. If the width of the inner cavity of the floater accommodating portion 132 is the same as the width of the floater 131, when the liquid level detection apparatus 130 inclines, the upper clamping portion 1311 cannot offset into the clamping groove 1322.

The distance between the clamping groove 1322 and a lower end of the moving groove 1321 is the same as the distance between the upper clamping portion 1311 and the lower clamping portion 1312. At this time, when the lower clamping portion 1312 is located at the lowest side of the moving groove 1321 of the floater accommodating portion 132, the upper clamping portion 1311 and the clamping groove 1322 are located on the same horizontal plane, and when the liquid level detection apparatus 130 inclines, the upper clamping portion 1311 offsets into the clamping groove 1322 under the action of the gravity of the floater 131; and if the distance between the clamping groove 1322 and a lower end of the moving groove 1321 is less than the distance between the upper clamping portion 1311 and the lower clamping portion 1312, after the liquid level detection apparatus 130 inclines, the upper clamping portion 1311 cannot offset into the clamping groove 1322 under the action of the gravity of the floater 131.

In an embodiment mode, the floater 131 is detachably connected in the floater accommodating portion 132, specifically, as shown in FIG. 4, both the upper clamping portion 1311 and the lower clamping portion 1312 are cylindrical, the bottom of the floater accommodating portion 132 is provided with an opening with an equivalent width for enabling the upper clamping portion 1311 and the lower clamping portion 1312 to pass through, therefore, the cylindrical upper clamping portion 1311 and the cylindrical lower clamping portion 1312 conveniently pass through the bottom of the floater accommodating portion 132, and the bottom of the moving groove 1321 is provided with a limiting portion, such that the lower clamping portion 1312 is clamped in the moving groove 1321, and the upper clamping portion 1311 and the lower clamping portion 1312 is prevented from dropping from the moving groove 1321 in the case of a relatively small external force, and the upper clamping portion 1311 and the lower clamping portion 1312 pass through the limiting portion in an interference fit manner. In other embodiments, other clamping structures is able to be used, only one feasible solution is given herein, which is not specifically limited. Each corner of the limiting portion of the moving groove 1321 is made into an R corner, which facilitates the interference fit for use.

As shown in FIG. 6 and FIG. 7, in an embodiment mode, the floater 131 includes an upper portion 1313 and a lower portion 1314, the upper portion 1313 moves in the floater accommodating portion 132, both the upper clamping portion 1311 and the lower clamping portion 1312 are located on the upper portion 1313, and the lower portion 1314 extends towards one side, such that an included angle is formed between the upper portion 1313 and the lower portion 1314. As shown in FIG. 4 and FIG. 5, when the user does not use the cleaning device 1000, the sewage tank 100 is in an upright state, at this time, the upper portion 1313 is in an upright state perpendicular to the horizontal plane, and the lower portion 1314 inclines towards a use side of the user; and as shown in FIG. 6 and FIG. 7, when the user uses the cleaning device 1000, the sewage tank 100 is in an inclined state, at this time, the upper portion 1313 is in the inclined state, the lower portion 1314 is in the upright state perpendicular to the horizontal plane, the acting force of water in the sewage tank 100 on the floater 131 is in a vertical state, and other component forces are not generated. Compared with a straight plate type floater, a bent floater may achieve the same buoyancy effect as the straight plate type floater through a smaller size, thereby increasing the actual capacity of the sewage tank 100. In an embodiment mode, the included angle is an obtuse angle, and at this time, the included angle matches the heights and usage habits of most users, so as to ensure that the lower portion 1314 is in the upright state during the use of the users. As shown in FIG. 3 and FIG. 5, the lower portion 1314 is provided with a groove 1315 for the liquid inlet pipe 111 to pass through.

In an embodiment mode, the sewage tank 100 further includes a solid-liquid separation apparatus 140, and one end of the solid-liquid separation apparatus 140 is hinged with the floater accommodating portion 132, such that the solid-liquid separation apparatus 140 rotates relative to the floater accommodating portion 132, and thus the solid dirt in the solid-liquid separation apparatus 140 is poured conveniently.

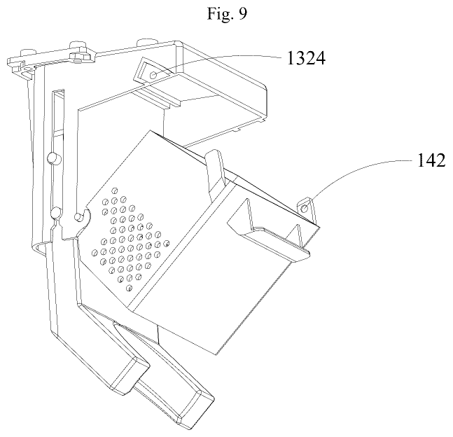

Specifically, as shown in FIG. 8 and FIG. 9, an outer side of the floater accommodating portion 132 is provided with an open accommodating groove 1323, one end of the solid-liquid separation apparatus 140 is provided with a protrusion 141, and the protrusion 141 is placed in the open accommodating groove 1323, such that the solid-liquid separation apparatus 140 rotates relative to the floater accommodating portion 132. In the present embodiment, the open accommodating groove 1323 is a U-shaped groove, such that the protrusion 141 is easily clamped into the open accommodating groove 1323 or taken from the open accommodating groove 1323 from upper side of the U-shaped groove, and then the solid-liquid separation apparatus 140 is detached from and installed on the floater accommodating portion 132 conveniently. The protrusion 141 rotates in the open accommodating groove 1323 with the protrusion 141 as the axis, so as to drive the solid-liquid separation apparatus 140 to rotate with the protrusion 141 as the axis. In other embodiments, the floater accommodating portion 132 and the solid-liquid separation apparatus 140 is connected in a closed hinging manner, such that the connection is more stable.

The other end of the solid-liquid separation apparatus 140 is clamped with the floater accommodating portion 132, specifically, a clamping groove 1324 is formed in the floater accommodating portion 132, a clamping block 142 is provided at a relative position of the solid-liquid separation apparatus 140, and the clamping block 142 is embedded into the clamping groove 1324, such that the solid-liquid separation apparatus 140 and the floater accommodating portion 132 remain relatively fixed. In other embodiments, the other end of the solid-liquid separation apparatus 140 is clamped with the tank cover 120, and the clamping manner is not limited.

As shown in FIG. 5, an outer wall of the solid-liquid separation apparatus 140 is provided with a handle 143, thereby improving the operation experience of the user to disassemble and assemble the solid-liquid separation apparatus 140. The user holds the handle 143 and pulls it towards one side, the clamping block 142 on the solid-liquid separation apparatus 140 deviates from the clamping groove 1324 on the floater accommodating portion 132 under the action of the external force, at this time, the solid-liquid separation apparatus 140 partially deviates from the floater accommodating portion 132, and is partially hinged with the floater accommodating portion 132, further, when the open accommodating groove 1323 is used as a hinging portion, the solid-liquid separation apparatus 140 may completely deviate from the floater accommodating portion 132, such that the solid-liquid separation apparatus 140 is singly cleaned conveniently, and the dirt in the solid-liquid separation apparatus 140 is poured conveniently.

In the present embodiment, the liquid level detection apparatus 130 is provided on the tank cover 120, the liquid level detection apparatus 130 is taken out when the tank cover 120 is taken out, such that the solid-liquid separation apparatus 140 connected with the liquid level detection apparatus 130 is taken out, in this way, the solid-liquid separation apparatus 140 is flushed without staining hands. In addition, since the handle 143 is provided on an outer wall of the solid-liquid separation apparatus 140, the solid-liquid separation apparatus 140 is taken out by taking out the tank cover 120, then the outer surface of the solid-liquid separation apparatus 140, particularly, the handle 143, is flushed, at this time, when the handle 143 is held, the handle 143 is clean, therefore compared with directly taking out the solid-liquid separation apparatus from the sewage tank in the related art, when the structural solution of the disclosure is used, the user experience is better.

As shown in FIG. 3 and FIG. 5, the solid-liquid separation apparatus 140 includes a mounting hole 144, a bottom plate 145 and a lateral plate 146, the mounting hole 144 is formed in the bottom plate 145, a lower end of the lateral plate 146 is connected with an outer edge of the bottom plate 145, the bottom plate 145 are provided with a plurality of water leakage holes 147, and the mounting hole 144 allows the liquid inlet pipe 111 to pass through. A part of the lateral plate 146 abuts against the floater accommodating portion 132, which facilitates the connection between the protrusion 141 and the open accommodating groove 1323. The lateral plate 146 is able to be provided with a plurality of water leakage holes 147, thereby improving the efficiency of solid-liquid separation. Dirt such as sewage flows through the solid-liquid separation apparatus 140 by means of the liquid inlet pipe 111 at first, and after solid dirt is filtered out by the solid-liquid separation apparatus 140, liquid dirt flows to the bottom of the sewage tank 100.

The liquid level detection apparatus 130 of the disclosure includes the floater 131 and the floater accommodating portion 132, the upper clamping portion 1311 and the lower clamping portion 1312 are provided on the floater 131 in the vertical direction, the clamping groove 1322 is formed in the moving groove 1321 of the floater accommodating portion 132 in the horizontal direction, and when the sewage tank 100 inclines, the upper clamping portion 1311 offsets into the clamping groove 1322 to play a limiting role, such that the floater 131 not easily be sucked by the suction force to block the suction port 132, thereby avoiding resulting in the phenomenon that an alarm is given when the water is not full in fact.

The technical content and technical features of the disclosure have been disclosed as above, however, it may be understood that, under the creation idea of the disclosure, those skilled in the art may make various changes and improvements to the structures and materials described above, including combinations of technical features individually disclosed or claimed herein, and obviously include other combinations of these features. These variations and/or combinations all fall within the technical field involved in the disclosure, and fall within the protection scope of the claims of the disclosure.

What is claimed is:

1. A liquid level detection apparatus, comprising a floater and a floater accommodating portion, wherein the floater moves in the floater accommodating portion in a vertical direction;
an upper clamping portion and a lower clamping portion are provided on the floater in the vertical direction, a moving groove is formed in the floater accommodating portion, the moving groove extends in the vertical direction, and the upper clamping portion and the lower clamping portion move in the moving groove in the vertical direction; and
a clamping groove is formed in the moving groove extending along a horizontal direction, and when the liquid level detection apparatus inclines, the upper clamping portion offsets into the clamping groove.

2. The liquid level detection apparatus according to claim 1, wherein the upper clamping portion is cylindrical, and the clamping groove is an arc-shaped groove.

3. The liquid level detection apparatus according to claim 1, wherein a width of an inner cavity of the floater accommodating portion is greater than a width of the floater, such that the floater offsets in the floater accommodating portion.

4. The liquid level detection apparatus according to claim 1, wherein a distance between the clamping groove and a lower end of the moving groove is the same as a distance between the upper clamping portion and the lower clamping portion.

5. The liquid level detection apparatus according to claim 1, wherein the floater comprises an upper portion and a lower portion, the upper portion moves in the floater accommodating portion, and the lower portion extends towards one side, such that an included angle is formed between the upper portion and the lower portion.

6. A sewage tank, comprising:
a tank body, which is configured for storing dirt sucked by a cleaning device;
a tank cover, which is detachably connected to the tank body, wherein a suction port is formed in the tank cover; and
a liquid level detection apparatus, which is located in the sewage tank and is configured for detecting a liquid level in the tank body, wherein the liquid level detection apparatus is the liquid level detection apparatus according to claim 1.

7. The sewage tank according to claim 6, wherein the floater is located below the suction port, and the floater is able to block the suction port.

8. The sewage tank according to claim 6, wherein the liquid level detection apparatus further comprises a sensor, and the floater is provided below the sensor.

9. The sewage tank according to claim 6, wherein the sewage tank further comprises a solid-liquid separation apparatus, and one end of the solid-liquid separation apparatus is hinged with the floater accommodating portion, such that the solid-liquid separation apparatus rotates relative to the floater accommodating portion.

10. The sewage tank according to claim 9, wherein an outer side of the floater accommodating portion is provided with an open accommodating groove, one end of the solid-liquid separation apparatus is provided with a protrusion, and the protrusion is placed in the open accommodating groove, such that the solid-liquid separation apparatus rotates relative to the floater accommodating portion.

11. The sewage tank according to claim 9, wherein the other end of the solid-liquid separation apparatus is clamped with the floater accommodating portion or the tank cover.

12. The sewage tank according to claim 9, wherein an outer wall of the solid-liquid separation apparatus is provided with a handle.

13. The sewage tank according to claim 9, wherein the tank body comprises a tank body main body having an accommodating cavity, and a liquid inlet pipe extending from a bottom end of the tank body main body into the accommodating cavity, and the solid-liquid separation apparatus communicates with the liquid inlet pipe.

14. The sewage tank according to claim 13, wherein the solid-liquid separation apparatus comprises a mounting hole, a bottom plate and a lateral plate, the mounting hole is formed in the bottom plate, a lower end of the lateral plate is connected with an outer edge of the bottom plate, the bottom plate is provided with a plurality of water leakage holes, and the mounting hole allows the liquid inlet pipe to pass through.

15. The sewage tank according to claim 14, wherein a part of the lateral plate abuts against the floater accommodating portion.

16. The sewage tank according to claim 6, wherein the liquid level detection apparatus is detachably connected to the tank cover.

17. A cleaning device, comprising the sewage tank according to claim 6, wherein the sewage tank is detachably assembled on the cleaning device.

18. The sewage tank according to claim 6, wherein the upper clamping portion is cylindrical, and the clamping groove is an arc-shaped groove.

19. The sewage tank according to claim 6, wherein a width of an inner cavity of the floater accommodating portion is greater than a width of the floater, such that the floater offsets in the floater accommodating portion.

20. The sewage tank according to claim 6, wherein the floater comprises an upper portion and a lower portion, the upper portion moves in the floater accommodating portion, and the lower portion extends towards one side, such that an included angle is formed between the upper portion and the lower portion.
